(19) United States
(12) Patent Application Publication
(10) Pub. No.: US 2003/0055797 A1
(43) Pub. Date: Mar. 20, 2003

(54) Neural network system, software and method of learning new patterns without storing existing learned patterns

(76) Inventor: Seiji Ishihara, Yoshikawa-shi (JP)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 10/196,855

(22) Filed: Jul. 16, 2002

(30) Foreign Application Priority Data
Jul. 30, 2001 (JP) 2001-230487

(51) Int. Cl. G06E 1/00; G06E 3/00; G06N 3/02; G06G 7/00; G06F 15/18

(52) U.S. Cl. 706/15; 706/18; 706/19; 706/20

(57) ABSTRACT

Learning using a neural network is improved for a classification problem by recollecting input patterns from the learned data without storing the original input data patterns. The neural network includes input elements in an input layer, middle elements in a middle layer and output elements in an output layer. The elements between two layers are related with each other by a corresponding weight. An output function of the middle and output layers includes a radial basis function (RBF). The recollected input patterns are generated based upon two parameters including a first vector indicating a central position o the RBF and a second vector indicating a range and a direction of the RBF. The recollected input patterns are used to improve additional learning of a new set of input patterns.

### FIELD OF THE INVENTION

The current invention is generally related to a neural network system or neural network software, and more particularly related to a neural network system for and a neural network method of learning a new pattern without previously introducing a learning pattern based upon an approximation function for approximating non-linear functions to be applied to pattern recognitions and signal predictions.

### BACKGROUND OF THE INVENTION

T. Poggio and F. Girosi in “Networks for Approximation and Learning, “Proc. Of IEEE, Vol. 78, pp. 1481-1497 (1990) (Hereinafter Reference No. 1), have disclosed a method of implementing an expansion of a basic function based upon Radial Basic Function (RBF) on a network. The network is generally called Generalized RBF (GRBF) network. Using the GRBF network in the above reference, Yamauchi et al. disclosed an additional learning method in “Influenced Neural Networks for Recollection of Pattern and Additional Learning,” Proceeding of Electronic Information Communication Academy, Vol. J80-D-11, pp. 295-305 (1997) (Hereinafter Reference No. 2). The additional learning method is a process in which a portion to be influenced by an additional learning process is predicted and recollected based upon the already learned function forms. The additional learning method thus includes a learning process in which the newly predicted portion and new patterns are together learned.

By neural networks using a RBF as an output function in an output layer of multilayer perceptrons, a method improves the precision for rejecting the recognition of an unlearned class of patterns over the multilayer perceptron method. The method also includes an effective additional learning method for a new class of patterns based upon the characteristics of the RBF. The above method has been disclosed in “Module Neural Net using RBF Output Elements,” Ishihara and Mizuno, Japan Neural Net Academy, Vol. 6, No. 4, pp 203-217 (1999) (Hereinafter Reference No. 3).

In general, it is difficult to predict input patterns that have been used for learning based upon the synaptic weights in the already learned neural networks. On the other hand, in addition to the existing input pattern sets, new input patterns are often later added. For example, registered patterns belonging to a new class are often added in an individual recognition system. In order to correctly perform the above described additional learning using neural networks, it is necessary to relearn new input patterns and the existing input learning patterns in the neural networks. For this reason, although it is necessary to store the existing input patterns for learning, the memory storage capacity and the computation cost for learning undesirably increase as the number of input learning patterns increases.

Furthermore, given additional learning of a new class for a classification problem, it is also necessary to separately store the existing learning patterns or its distribution information in a certain format. One method to effectively perform additional learning of new patterns without storing the existing learning patterns is proposed in the above described Reference No. 2. However, the proposed additional learning method does not necessarily realize that the GRB networks perform a superior function than the multiple layered perceptron-type neural networks. The relative superiority between the two approaches changes depending upon a desired function form. In particular, in a classification problem for relating an input pattern to a desired class, there is a strong tendency to utilize the multiple layered perceptron-type neural networks. The efficient method of additionally learning a new class as disclosed in the above described Reference No. 3 requires no relearning of portions of patterns that belong to already added classes. For those portions that cannot be classified, relearning is necessary, and the existing learning patterns are necessary.

In view of the above described problems, it remains desired to predict the distribution form of learning patterns and to rearrange the patterns within a certain range. In other words, it remains desired to perform the additional learning of new patterns without storing the existing learning patterns.

### SUMMARY OF THE INVENTION

In order to solve the above and other problems, according to a first aspect of the current invention, a neural network, including: an input layer having 2ⁿ input elements; a middle layer having at least one middle element; an output layer having at least one output element and a RBF as an output function, an output value being determined by a first vector indicating a central position of the RBF and a second vector indicating a range and a direction of the RBF; and weights each indicating a relation between a pair of one of the input elements and a corresponding one of the middle elements, each of the weights being a product of a first predetermined value and a second predetermined value vᵢⱼ that corresponds to i th one of the input elements and (0, j) th one of the middle elements,

According to a second aspect of the current invention, a neural network system, including: a neural network for learning in response to input learning pattern signals and input teaching signals, the neural network having an input layer having 2ⁿ input elements where n is a positive integer, a middle layer having m middle elements where m is a natural number, an output layer having at least one output element and a RBF as an output function, an output value being determined by a first vector indicating a central position of the RBF and a second vector indicating a range and a direction of the RBF, weights each indicating a relation between a pair of one of the input elements and a corresponding one of the middle elements, each weight being a product of a first predetermined value αᵢ that corresponds to i th one of the input elements and a second predetermined value vᵢⱼ that corresponds to i th one of the input elements and (0, j) th one of the middle elements; a first update control unit connected to the neural network for updating the first vector, the second vector and the second predetermined value vᵢⱼ; a network control unit connected to the neural network and the first update control unit for adding m (2ⁿ−1) middle elements to the middle layer; and a second update control unit connected to the neural network for updating the first vector and the second vector.

According to a third aspect of the current invention, a method of learning a classification problem for grouping into classes using a neural network, the neural network including input elements in an input layer, middle elements in a middle layer, and output elements and a predetermined radial basis function (RBF) in an output layer, including the steps of: inputting first input pattern signals to the neural network; learning to classify the first input pattern signals into classes in a first predetermined learning stage; learning to classify the first input pattern signals into the classes in a second predetermined learning stage to generate already learned input pattern signals; after the first learning stage and the second learning stage, predicting an input pattern based the already learned input pattern signals; inputting second input pattern signals and the already learned input pattern signals; learning to classify the second input pattern signals into classes based upon the already learned input pattern signals in a first predetermined learning stage; and learning to classify the second input pattern signals into the classes in a second predetermined learning stage to generate already learned input pattern signals.

According to a fourth aspect of the current invention, a recording medium containing computer instructions for learning a classification problem for grouping into classes using a neural network, the neural network including input elements in an input layer, middle elements in a middle layer, and output elements and a predetermined radial basis function (RBF) in an output layer, the computer instructions performing the tasks of: inputting first input pattern signals to the neural network; learning to classify the first input pattern signals into classes in a first predetermined learning stage; learning to classify the first input pattern signals into the classes in a second predetermined learning stage to generate already learned input pattern signals; after the first learning stage and the second learning stage, predicting an input pattern based the already learned input pattern signals; inputting second input pattern signals and the already learned input pattern signals; learning to classify the second input pattern signals into classes based upon the already learned input pattern signals in a first predetermined learning stage; and learning to classify the second input pattern signals into the classes in a second predetermined learning stage to generate already learned input pattern signals.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagram illustrating elements of a first preferred embodiment of the neural network in the first learning stage according to the current invention.

FIG. 2 is a diagram illustrating elements of a first preferred embodiment of the neural network in the second learning stage according to the current invention.

FIG. 3 is a block diagram illustrating functional components of a preferred embodiment of the neural network system according to the current invention.

FIG. 4 is a flow chart illustrating steps involved in a preferred process of learning in the above described neural network according to the current invention.

FIG. 5 is a flow chart illustrating steps involved in a preferred process of recollecting input patterns based upon the learning results in the above described neural network according to the current invention.

FIG. 6 is a flow chart illustrating steps involved in a preferred process of additional learning after recollecting input patterns based upon the learning results in the above described neural network according to the current invention.

### DETAILED DESCRIPTION OF THE PREFERRED EMBODIMENT(S)

In classification-related problems in learning, the current inventive process generally includes a first learning step for separating a corresponding class and others and a second learning step forming a filter in a middle layer based upon an algorithm for dividing wavelets. The first learning step updates an error in three parameter vectors based upon the error back propagation method. The three parameters include the synaptic weights between an input layer and a middle layer, a center position vector for a RBF and a vector defining the scope and incline of the RBF. The second learning step adds middle elements to the middle elements in the first learning step and also updates two previously described parameters. The two parameters include the center position vector for a RBF and the vector for defining the scope and incline of the RBF. After the second learning step, an area for each class is predicted in the output area of the middle layer based upon the center position vector for a RBF and the vector for defining the scope and incline of the RBF. From the above predictions, an output vector in the middle layer is selected from each dimensional boundary points, and an input pattern is predicted based upon the wavelet rearrangement algorithm.

(1) The Components of the Neural Network According to the Current Invention

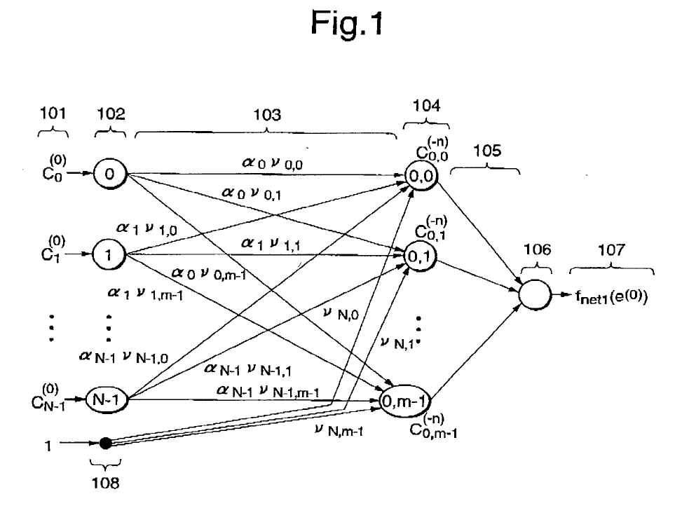

Referring now to the drawings, wherein like reference numerals designate corresponding structure throughout the views, and referring in particular to FIG. 1, a diagram illustrates elements of a first preferred embodiment of the neural network in the first learning stage according to the current invention. The neural network includes three layers including an input layer 102, a middle layer 104 and an output layer 106. The input layer 102 further includes N input elements 0 through N−1 and a single bias element 108. The middle layer 104 and the output layer 106 respectively further include m middle elements (0, 0) through (0, m−1) and a single output element. The first preferred embodiment also further includes combined weights 103, which indicate a connection bias value between the input layer 102 and the middle layer 104. Similarly, the first preferred embodiment also further includes synaptic weights 105, which indicate a connection bias value between the middle layer 104 and the output layer 106.

Still referring to FIG. 1, the input element is referred to by a reference number ranging from 0 to N−1, where N is 2′ and n is an arbitrary positive integer. In the following disclosure, an input element i refers to an ith input element. The bias element 108 is a special element for expressing a bias value for each of the middle elements (0, 0) through (0, m−1) in the middle layer, and it is assumed to have a constant input value of 1. The m middle element in the middle layer 104 is respectively referred to by a reference numeral ranging from (0, 0) to (0, m−1), where m is an arbitrary natural number. In the following disclosure, a middle element (0, j) refers to a 0, j th middle element. For example, an output function in the middle layer 104 is a sigmoid function. An output function in the output layer 106 is a RBF such as Gauss function. Although the first preferred embodiment includes a single output element, other preferred embodiments include a plurality of output elements.

The combined weights 103 include a predetermined value αᵢ; Nm combined weights that are each a product of the input element i and a value V_{i, J} that corresponds to a middle element (i, j); and m bias-related weights that each correspond to Vₙⱼ. The value αᵢ, is determined by a type of wavelet when the input element i undergoes a predetermined wavelet analysis. The weights 105 include m combined weights, and the value of each combined weight in the weights 105 is always 1. Assuming that a combined weight A from the input layer 102 to the middle layer 104 is as follows:

$$A = [ \begin{matrix}{α}_{0} {v}_{0 , 0} & ⋯ & {α}_{0} {v}_{0 , m - 1} \\ ⋮ & ⋰ & ⋮ \\ {α}_{N - 1} {v}_{N - 1 , 0} & ⋯ & {α}_{N - 1} {v}_{N - 1 , m - 1} \\ {v}_{N , 0} & ⋯ & {v}_{N , m - 1}\end{matrix} ] \qquad ( 1 )$$

The input pattern 101 has an input pattern vector c⁽⁰⁾=(c₀⁽⁰⁾, . . . , c_{N-1}⁽⁰⁾, 1). The middle layer 104 has a corresponding output pattern vector c^{(-N)}=(c_{0,0}⁽⁻ⁿ⁾, . . . , c_{0, m-1}⁽⁻ⁿ⁾. The corresponding output pattern vector is defined to be c⁽⁻ⁿ⁾=S (c⁽⁰⁾A), where S is a Sigmoid function and A is the combined weight as shown in the Equation (1).

Assuming that the central position of a Gauss function is a vector t_{net 1}=(t_{0,0}. . . , t_{0,m-1}), the output 107 (fₙₑₜ(c⁽⁰⁾)) from the output layer 106 for the input pattern vector c⁽⁰⁾ is expressed in the following equation:

$$\begin{matrix}{f}_{net1} ( {c}^{( 0 )} = G ( {‖ {c}^{( - n )} - {t}_{net1} ‖}_{{W}_{net1}}^{2} ) \\ = exp ( - ( {c}^{( - n )} - {t}_{net1} ) {W}_{net1}^{T} {{W}_{net1} ( {c}^{( - n )} - {t}_{net1} )}^{T} )\end{matrix} \qquad ( 2 )$$

where T is a transposed matrix, and G is a Gauss function. Where weight matrix W_{net 1}is a matrix below to define an incline and the distribution range.

$${W}_{net1} = [ \begin{matrix}{w}_{( 0 , 0 ) , ( 0 , 0 )} & ⋯ & {w}_{( 0 , 0 ) , ( 0 , m - 1 )} \\ ⋮ & ⋰ & ⋮ \\ {w}_{( 0 , m - 1 ) , ( 0 , 0 )} & ⋯ & {w}_{( 0 , m - 1 ) , ( 0 , m - 1 )}\end{matrix} ] \qquad ( 3 )$$

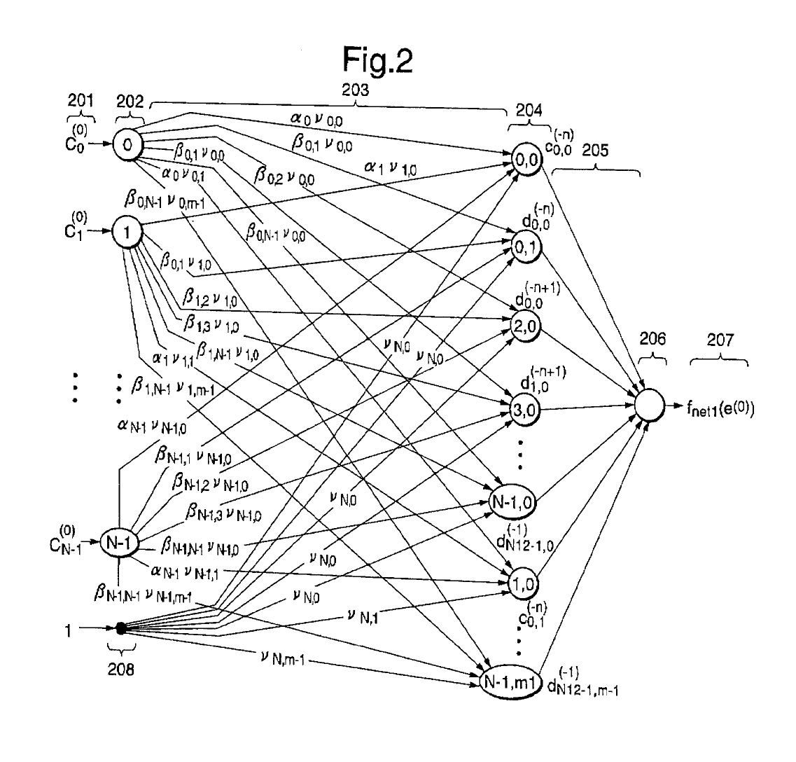

Now referring to FIG. 2, a diagram illustrates elements of a first preferred embodiment of the neural network in the second learning stage according to the current invention. The neural network includes three layers including an input layer 202, a middle layer 204 and an output layer 206. The input layer 202 further includes N input elements 0 through N−1 and a single bias element 208. The middle layer 204 and the output layer 206 respectively further include Nm middle elements (0, 0) through (N-1, m−1) and a single output element. The first preferred embodiment also further includes synaptic weights 203, which indicate a connection bias value between the input layer 202 and the middle layer 204. Similarly, the first preferred embodiment also further includes combined weights 205, which indicate a connection bias value between the middle layer 204 and the output layer 206. The layer 202 further includes elements that are substantially identical to those in the input layer 102 in the first learning stage of the first preferred embodiment according to the current invention. The bias element 208 is a special element for expressing a bias value, and it is assumed to have a constant input value of 1. The Nm middle element in the middle layer 204 is respectively referred to by a reference numeral ranging from (0, 0) to (N-1, m-1), where N=2ⁿ and n is an arbitrary positive integer while m is an arbitrary natural number. The above N and m are used in the same sense as in the first stage of the first preferred embodiment of the neural network according to the current invention. In the following disclosure, a middle element (z, j) refers to a z, j th middle element. For example, a Sigmoid function is used for the output function of the middle layer 204. As in the above described output layer 106 an output function in the output layer 206 is a RBF such as Gauss function. Although the first preferred embodiment includes a single output element, other preferred embodiments include a plurality of output elements.

Still referring to FIG. 2, the weights 203 include a predetermined value αᵢ or a predetermined value β_{i, z}; N²m combined weights that are each a product of the input element i and a value V_{i,j} that corresponds to a middle element (i, j); and m bias-related weights that each correspond to Vₙⱼ . The value αᵢ is determined by a type of wavelet when the input element i undergoes a predetermined wavelet analysis. The predetermined value β_{i, z} . is referenced by a pair of indexes that corresponds to the input element I and the middle element (z, j). The combined weights 205 include Nm combined weights, and the value of each combined weight in the combined weights 205 is always 1. Assuming that the combined weight B from the input layer 202 to the middle layer 204 is as follows:

$$\begin{matrix}B = [ \begin{matrix}{B}_{0} & ⋯ & {B}_{j} & ⋯ & {B}_{m - 1} ] ,\end{matrix} & \\ {B}_{j} = [ \begin{matrix}{α}_{0} {v}_{0 , j} & {β}_{0 , 1} {v}_{0 , j} & ⋯ & {β}_{0 , N - 1} {v}_{0 , j} \\ ⋮ & ⋮ & ⋰ & ⋮ \\ {α}_{N - 1} {v}_{N - 1 , j} & {β}_{N - 1 , 1} {v}_{N - 1 , j} & ⋯ & {β}_{N - 1 , N - 1} {v}_{N - 1 , j} \\ {v}_{N - j} & {v}_{N , j} & ⋯ & {v}_{N , j}\end{matrix} ] & ( 4 )\end{matrix}$$

The input pattern 201 has an input pattern vector c⁽⁰⁾=(c₀⁽⁰⁾, . . . , C_{N-1}⁽⁰⁾, 1). The middle layer 204 has a corresponding output pattern vector y=[y₀. . . y_{J}. . . yₘ₋₁]. The corresponding output pattern vector is defined to be y=S(c⁽⁰⁾B), where S is a Sigmoid function and y_{J}=(c_{0,j}⁽⁻ⁿ⁾,d_{0,j}⁽⁻ⁿ⁾,d_{0,j}⁽⁻ⁿ⁺¹⁾,d_{1,j}⁽⁻ⁿ⁺¹⁾, . . . d_{a,j}^{(-n+b)}, . . . , d_{N/2-1,j}⁽⁻¹⁾) . Furthermore, b in the above equation is (b=0, . . . , n−1; a=0 , . . . , 2^{b}−1) . Assuming that the central position of a Gauss function is a vector tₙₑₜ₂=(t_{0,0}, . . . t_{N-1, 0}, t_{0,1},t_{N-1,m-1}) , the output 207 (fₙₑₜ₂(c⁽⁰⁾)) from the output layer 206 for the input pattern vector c⁽⁰⁾ is expressed in the following equation:

$$\begin{matrix}{f}_{net2} ( {c}^{( 0 )} ) = G ( {‖ y - {t}_{net2} ‖}_{{W}_{net2}}^{2} ) \\ = exp ( - ( y - {t}_{net2} ) {W}_{net2}^{T} {{W}_{net2} ( y - {t}_{net2} )}^{T} )\end{matrix} \qquad ( 5 )$$

where weight matrix Wₙₑₜ₂ is the following matrix (6) that indicates weights.

$${W}_{net2} = [ \begin{matrix}{w}_{( 0 , 0 ) , ( 0 , 0 )} & ⋯ & {w}_{( 0 , 0 ) , ( N - 1 , 0 )} & {w}_{( 0 , 0 ) , ( 0 , 1 )} & ⋯ & {w}_{( 0 , 0 ) , ( N - 1 , m - 1 )} \\ ⋮ & ⋰ & ⋮ & ⋮ & ⋰ & ⋮ \\ {w}_{( N - 1 , 0 ) , ( 0 , 0 )} & ⋯ & {w}_{( N - 1 , 0 ) , ( N - 1 , 0 )} & {w}_{( N - 1 , 0 ) , ( 0 , 1 )} & ⋯ & {w}_{( N - 1 , 0 ) , ( N - 1 , m - 1 )} \\ {w}_{( 0 , 1 ) , ( 0 , 0 )} & ⋯ & {w}_{( 0 , 1 ) , ( N - 1 , 0 )} & {w}_{( 0 , 1 ) , ( 0 , 1 )} & ⋯ & {w}_{( 0 , 1 ) , ( N - 1 , m - 1 )} \\ ⋮ & ⋰ & ⋮ & ⋮ & ⋰ & ⋮ \\ {w}_{( N - 1 , m - 1 ) ( 0 , 0 )} & ⋯ & {w}_{( N - 1 , m - 1 ) ( N - 1 , 0 )} & {w}_{( N - 1 , m - 1 ) ( 0 , 1 )} & ⋯ & {w}_{( N - 1 , m - 1 ) ( N - 1 , m - 1 )}\end{matrix} ] \qquad ( 6 )$$

The predetermined value αᵢ is shown in the first and second learning stages of the neural networks in FIGS. 1 and 2. The predetermined value αᵢ is a coefficient of the right term Ci⁽⁰⁾ which corresponds to the left term Ci⁽⁻ⁿ⁾ when the break down algorithm for wavelet as shown in the following equation 7 is recursively applied from b=0, . . . , n−1. Similarly, the predetermined value , is a coefficient of the right term Ci⁽⁰⁾ which corresponds to the left term dₖ^{(-b-1)} when the break down algorithm for wavelet as shown in the following equations 7 or 8 is recursively applied from b=0, . . . , n−1.

$$\begin{matrix}{c}_{k}^{( - b - 1 )} = 1 / 2 {\sum }_{1} {g}_{2 k - 1} {c}_{1}^{( - b )} , ( k = 0 , ⋯ , {2}^{n - b - 1} - 1 ) & ( 7 ) \\ {d}_{k}^{( - b - 1 )} = 1 / 2 {\sum }_{1} {h}_{2 k - 1} {c}_{1}^{( - b )} , ( k = 0 , ⋯ , {2}^{n - b - 1} - 1 ) & ( 8 )\end{matrix}$$

Where Z=k+2^{n-b-1}. g₂ₖ₋₁ and h₂ₖ₋₁ are a splitting matrix that depends upon a type of wavelet. Furthermore, depending upon the wavelet type, it is necessary to impose a periodic boundary condition on c₁^{(-b)}. The value of αᵢ and β_{i, z} is independently determined from the index (z, j) of the middle element.

(2) The Functional Components of the Neural Network According to the Current Invention

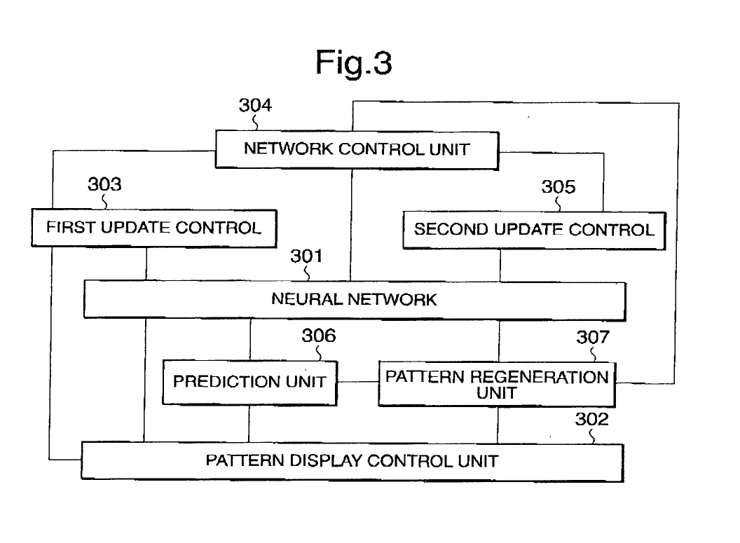

Now referring to FIG. 3, a block diagram illustrates functional components of a preferred embodiment of the neural network system according to the current invention. The neural network system includes a neural network 301, a pattern display control unit 302, a first update control unit 303, a network control unit 304, a second update control unit 305 , a prediction unit 306 and a pattern regeneration or rearrangement unit 307. The neural network 301 further includes the above described first and second learning stages as already described with respect to FIGS. 1 and 2. However, in an initial stage, the neural network 301 configures itself to have the elements of the first learning stage. The pattern display control unit 302 inputs the input patterns into the neural network 301 for learning and sends corresponding teaching signals to the first update control unit 303 and the second update control unit 305. The first update control unit 303 updates a predetermined set of parameters based upon the difference between the teaching signals that are displayed by the pattern display control unit 302 and the output value from the first learning stage of the neural network 301.

Still referring to FIG. 3, after the first update control unit 303 completes the above update or the pattern regeneration unit 307 completes the recollection, the network control unit 304 modifies the components of the neural network 301. In other words, when the first update control unit 303 completes the above update, the network control unit 304 modifies the components of the neural network 301 from those of the first learning stage as shown in FIG. 1 to those of the second learning stage as shown in FIG. 2. On the other hand, when the pattern regeneration unit 307 completes the recollection, the network control unit 304 modifies the components of the neural network 301 from those of the second learning stage as shown in FIG. 2 back to those of the first learning stage as shown in FIG. 1. After the first update control unit 303 completes the above update and the network control unit 304 completes the above modification, the second update control unit 305 updates a predetermined set of parameters base upon a difference between the teaching signals from the pattern display control unit 302 and the output value from the neural network 301 in the second learning stage configuration. Based upon the predetermined parameters of the neural network 301 as shown in FIG. 2, the prediction unit 306 predicts a distribution area for already learned input patterns in an output space of the middle layer. The pattern regeneration unit 307 rearranges or regenerates the input patterns based upon a predetermined point in the distribution area that the prediction unit 306 has predicted.

(3) Learning Method

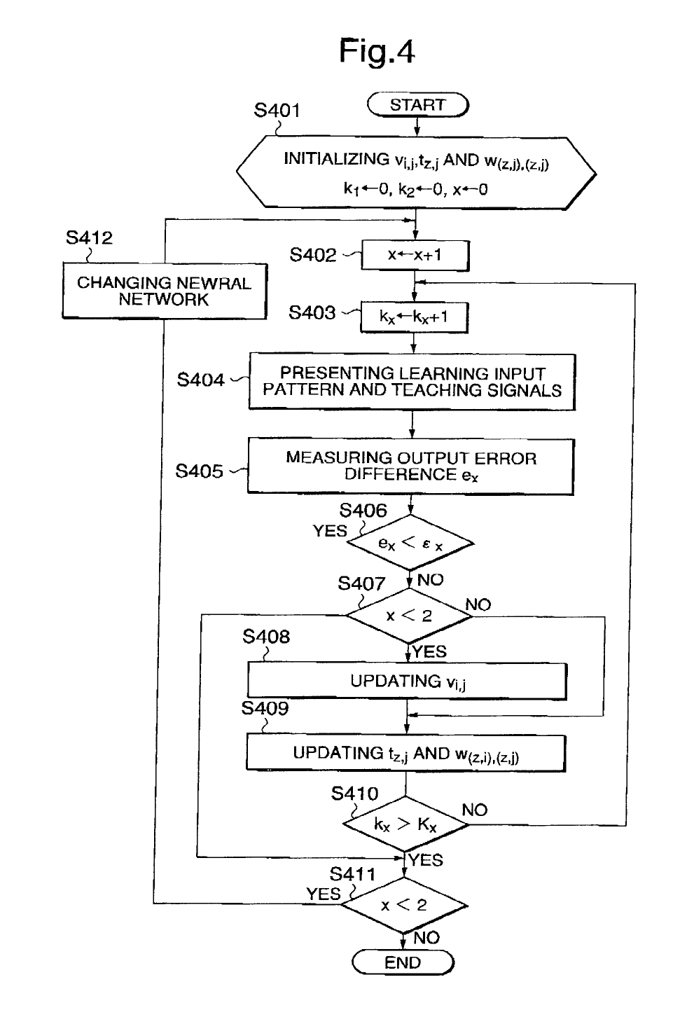

Now referring to FIG. 4, a flow chart illustrates steps involved in a preferred process of learning in the above described neural network according to the current invention. The v_{i,j} corresponds to a index pair of an input element (i) and a middle element (z, j). The vector element t_{z,j} defines a central position of the Gauss function. W_{(z,j), (z,j)} defines a weight in a weight matrix. In a step S401, each of v_{i, j}, t_{z,j} and W_{(z,j) (z,j)} are initialized to an arbitrarily predetermined initial value. Repeat counters k₁, k₂ and a variable x are initialized to zero also in the step S401. The repeat counters k₁, k₂ keep a value indicating a number of repetition for the first and second updates. The neural network 301 is initialized to the first learning stage as shown in FIG. 1. In a step S402, the variable x is incremented by one. In a step S403, the repeat counter kₓ is incremented by one where the subscript x is the variable x. For example, if x=1, the repeat counter k₁ is referenced while if x=2, the repeat counter k₂ is referenced. In a step S404, the input patterns for learning are inputted into the neural network, and the corresponding teaching signals are shown to the neural network. In a step S405, an ouput difference eₓ. between the neural network output value and the teaching signal is measured. For example, the output difference eₓ is determined by mean square error. An arbitrary condition value εₓ indicates a condition for completing learning based upon the output difference eₓ. The arbitrary condition value εₓ and the output difference eₓ are compared in a step S406. If the output difference e, is smaller than the arbitrary condition value εₓ, the preferred process proceeds to a step S411.

Still referring to FIG. 4, on the other hand, if the output difference eₓ is not sufficiently converged or is not smaller than the arbitrary condition value εₓ, the variable x value is compared to a value, 2 in a step S407. If the variable value x is not smaller than 2, it is considered to be in the second learning stage, and the preferred process proceeds to a step S409. On the other hand, the variable value x is smaller than 2, since it is in the first learning stage, the value v_{i, j} is updated by applying an error back propagation method in a step S408. Furthermore, each element t_{z,j} in the vector defining a central position of the Gauss function and each element in the matrix w_{(z,j), (z,j)} are updated by applying the error back propagation method in a step S409. In a step S410, the repeat counter counter kₓ is compared to an arbitrarily predetermined learning completion value Kₓ. If the repeat counter kₓ contains a value that is not larger than the completion value Kₓ, the preferred process goes back to the step S403. On the other hand, repeat counter kₓ contains a value that is larger than the completion value Kₓ, the variable x value is compared to a value, 2 in a step S411. If the variable value x is not smaller than 2, it is considered to have finished the second learning stage, and the preferred process proceeds to terminate. On the other hand, the variable value x is smaller than 2, since it is considered to have finished the first learning stage, the preferred process goes to a step S412, where the neural network is reconfigured for the second learning stage. That is, a new set of (N−1) middle elements are added for an existing single middle element. Furthermore, by adding new weights between the newly added middle elements and the input elements and between the middle elements and the output elements, the neural network in the first learning stage as shown in FIG. 1 is modified into the neural network in the second learning stage as shown in FIG. 2 in the step S412. The preferred process then proceeds to the step S402, where the second learning stage begins to take place.

(4) Input Pattern Recollection Method

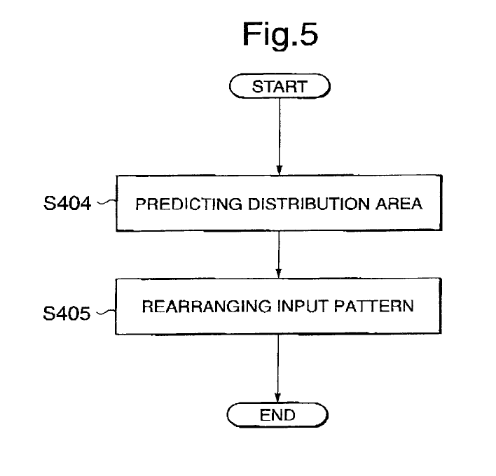

Now referring to FIG. 5, a flow chart illustrates steps involved in a preferred process of recollecting input patterns based upon the learning results in the above described neural network according to the current invention. Upon completing the second learning stage, the distribution of the already-used input patterns for learning is predicted in the output space of the middle layer in the neural network in the second learning stage based upon the vector tₙₑₜ₂ for defining a central position of the Gauss function and the weight matrix Wₙₑₜ₂ in a step S501. For example, the area is calculated in the output space that is defined by the output value fₙₑₜ₂(c⁽⁰⁾) exceeding a predetermined arbitrary value. In general, if Wₙₑₜ₂ and tₙₑₜ₂ in the Equation (5) are known, a point y in the corresponding area is easily determined. In a step S502, the input pattern c⁽⁰⁾=(c_{0,j}⁽⁰⁾, 1) is rearranged and regenerated by recursively applying to an element y, of the above predicted area the wavelet rearrange algorithm as specified by the following Equation (9) from b=0 to n−1 where yⱼ=(c_{0, j}⁽⁻ⁿ⁾, d_{0, j}⁽⁻ⁿ⁾, d_{0, j}⁽⁻ⁿ⁺¹⁾, d_{1, j}⁽⁻ⁿ⁺¹⁾, . . . d_{a, j}^{(-n+b)}, . . . , d_{N/2-1, j}⁽⁻¹⁾

$${c}_{k , j}^{( - n + b + 1 )} = {\sum }_{1} [ {P}_{k - 21} {c}_{1 , j}^{( - n + b )} + {q}_{k - 21} {d}_{1 , j}^{( - n + b )} ] , ( k = 0 , ⋯ , {2}^{b + 1} - 1 ) \qquad ( 9 )$$

Where Pₖ₋₂₁ and qₖ₋₂₁ are a rearrangement matrix that depends upon a type of wavelet. Furthermore, depending upon the wavelet type, it is necessary to impose a periodic boundary condition on c_{, j}^{(-n+b)} and d_{1, j}^{(-n+b)}. An exemplary y value is a point on the boundary or a central point.

(5) Additional Learning Method According to the Current Invention

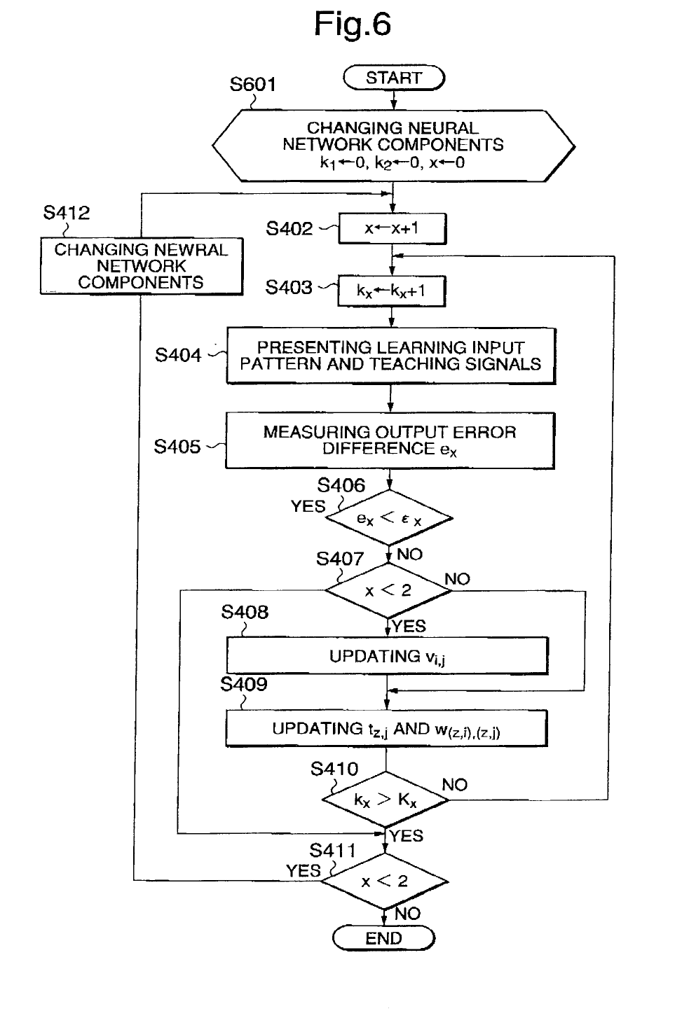

Now referring to FIG. 6, a flow chart illustrates steps involved in a preferred process of additional learning after recollecting input patterns based upon the learning results in the above described neural network according to the current invention. At the beginning of the preferred process, the neural network is assumed to be in the second learning stage as shown in FIG. 2. In a step S601, the middle elements that are not referenced by (0, j) are deleted from the neural network in order to change the second learning stage configuration back to the first learning stage configuration as shown in FIG. 1. Furthermore, the counters k₁, k₂ and a variable x are initialized to zero also in the step S601. In a step S402, the variable x is incremented by one. In a step S403, the repeat counter kₓ is incremented by one where the subscript x is the variable x. For example, if x=1, the repeat counter k₁ is referenced while if x=2, the repeat counter k₂ is referenced. In a step S604, newly added input patterns or recollected input patterns for learning are inputted into the neural network, and the corresponding teaching signals are shown to the neural network. In a step S405, an output difference eₓ between the neural network output value and the teaching signal is measured. For example, the output difference eₓ is determined by mean square error. An arbitrary condition value εₓ indicates a condition for completing learning based upon the output difference eₓ. The arbitrary condition value εₓ and the output difference eₓ are compared in a step S406. If the output difference eₓ is smaller than the arbitrary condition value εₓ, the preferred process proceeds to a step S411.

Still referring to FIG. 6, on the other hand, if the output difference eₓ is not sufficiently converged or is not smaller than the arbitrary condition value εₓ, the variable x value is compared to a value, 2 in a step S407. If the variable value x is not smaller than 2, it is considered to be in the second learning stage, and the preferred process proceeds to a step S409. On the other hand, the variable value x is smaller than 2, since it is in the first learning stage, the value v_{i, j} is updated by applying an inverse error diffusion method in a step S408. Furthermore, each element t_{z,j}. in the vector defining a central position of the Gauss function and each element in the matrix w_{(z,j), (z,j)} are updated by applying the inverse error diffusion method in a step S409. In a step S410, the repeat counter counter kₓ is compared to an arbitrarily predetermined learning completion value Kₓ. If the repeat counter kₓ contains a value that is not larger than the completion value Kₓ, the preferred process goes back to the step S403. On the other hand, repeat counter kₓ contains a value that is larger than the completion value Kₓ, the variable x value is compared to a value, 2 in a step S411. If the variable value x is not smaller than 2, it is considered to have finished the second learning stage, and the preferred process proceeds to terminate. On the other hand, the variable value x is smaller than 2, since it is considered to have finished the first learning stage, the preferred process goes to a step S412, where the neural network is reconfigured for the second learning stage. That is, a new set of (N−1) middle elements are added for an existing single middle element. Furthermore, by adding new weights between the newly added middle elements and the input elements and between the middle elements and the output elements, the neural network in the first learning stage as shown in FIG. 1 is modified into the neural network in the second learning stage as shown in FIG. 2 in the step S412. The preferred process then proceeds to the step S402, where the second learning stage begins to take place.

As described above, the neural network or the neural network system predicts the distribution of the existing learning patterns when a new learning pattern is added. Since the neural network or the neural network system recollects the existing learning patterns by rearranging the patterns within a certain range, it is not necessary to store the existing learning patterns. For the above reasons, the computational costs and the memory capacity that are associated with neural network learning are substantially reduced.

Although the above descriptions illustrated certain specific examples, the current invention is practiced in other ways. For example, referring to FIG. 6, the neural network system is implemented as a software program, and the software program is written to a recording medium such as a CD-ROM. The current invention is thus practiced by a computer that includes a CD-ROM driver and a central processing unit (CPU). The CPU reads the software program on the CD-ROM via the CD-ROM driver into a memory or a memory unit and executes the program. The software program itself that is read from the recording medium implements the functions of the above preferred embodiment, and the software program and the recording medium recording the software program both implement the invention. Furthermore, the recording medium includes semiconductor media such as ROM, non-volatile memory cards, optical media such as DVD, MO, MD, CD-R, and magnetic media such as magnetic tape and flexible disks. In addition to implementing the functions of the above preferred embodiment by executing the loaded software program, the functions of the above preferred embodiment are alternatively implemented by a partial or whole handling by an external system program such as an operating system in response to the instructions by the software program. When a software computer program is stored in a storage unit in a server computer for distributing the software program by downloading it to a user computer through a communication network such as the Internet, the storage unit in the server computer is also considered to be the recording medium.

As described above, the neural network utilizes the RBF in the output layer of the multiple perceptrons for the classification problem and is integrated with a wavelet dividing algorithm. The above neural network predicts the input learning pattern distribution area in output space of the middle layer and recollects a finite number of input patterns from a point in the predicted area. By using the predicted patterns as existing input patterns for additional learning, the computational costs and the memory capacity are substantially reduced because it is not necessary to store the existing learning patterns.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A neural network, comprising:
an input layer having 2ⁿ input elements;
a middle layer having at least one middle element;
an output layer having at least one output element and a RBF as an output function, an output value being determined by a first vector indicating a central position of the RBF and a second vector indicating a range and a direction of the RBF; and
weights each indicating a relation between a pair of one of the input elements and a corresponding one of the middle elements, each of the weights being a product of a first predetermined value and a second predetermined value v_{i,j} that corresponds to i th one of the input elements and (0, j) th one of the middle elements.

2. The neural network according to claim 1 wherein the first predetermined value is αᵢ that corresponds to i th one of the input elements.

3. The neural network according to claim 2 wherein the first predetermined value αᵢ is based upon a splitting matrix for a predetermined wavelet splitting algorithm.

4. The neural network according to claim 1 wherein the first predetermined value is β_{i,z} that corresponds to (z, j) th one of the middle elements.

5. The neural network according to claim 4 wherein the first predetermined value β_{i,z} is based upon a splitting matrix for a predetermined wavelet splitting algorithm.

6. A neural network system, comprising:
a neural network for learning in response to input learning pattern signals and input teaching signals, the neural network having an input layer having 2ⁿ input elements where n is a positive integer, a middle layer having m middle elements where m is a natural number, an output layer having at least one output element and a RBF as an output function, an output value being determined by a first vector indicating a central position of the RBF and a second vector indicating a range and a direction of the RBF, weights each indicating a relation between a pair of one of the input elements and a corresponding one of the middle elements, each weight being a product of a first predetermined value αᵢ that corresponds to i th one of the input elements and a second predetermined value v_{i,j} that corresponds to i th one of the input elements and (0, j) th one of the middle elements;
a first update control unit connected to said neural network for updating the first vector, the second vector and the second predetermined value v_{i,j};
a network control unit connected to said neural network and said first update control unit for adding m (2ⁿ−1) middle elements to the middle layer; and
a second update control unit connected to said neural network for updating the first vector and the second vector.

7. The neural network system according to claim 6 further comprising:
a prediction unit connected to said neural network for predicting an input distribution area in an output area of the middle layer for input learning patter signals that have been already learned, said prediction unit based upon the first vector, the second vector and a difference between an output value from the output layer and the input teaching signals; and
a pattern regeneration unit connected to said prediction unit and said neural network for approximating the input learning pattern signals from a point in the output area of the middle layer.

8. The neural network system according to claim 7 wherein said pattern regeneration unit regenerates the input learning pattern signals based upon a predetermined wavelet regeneration algorithm.

9. The neural network system according to claim 8 wherein said pattern regeneration unit regenerates the input learning pattern signals from a point on a boundary of the input distribution area.

10. The neural network system according to claim 8 wherein said pattern regeneration unit regenerates the input learning pattern signals from an area central point of the output area of the middle layer, the area central point corresponding to the central position of the RBF.

11. The neural network system according to claim 8 wherein said first update control unit, said second update control unit and said network control unit perform an additional learning process of new input pattern signals after the m (2ⁿ−1) middle elements have been deleted

12. A method of learning a classification problem for grouping into classes using a neural network, the neural network including input elements in an input layer, middle elements in a middle layer, and output elements and a predetermined radial basis function, (RBF) in an output layer, comprising the steps of:
inputting first input pattern signals to the neural network;
learning to classify the first input pattern signals into classes in a first predetermined learning stage;
learning to classify the first input pattern signals into the classes in a second predetermined learning stage to generate already learned input pattern signals;
after the first learning stage and the second learning stage, predicting an input pattern based the already learned input pattern signals;
inputting second input pattern signals and the already learned input pattern signals;
learning to classify the second input pattern signals into classes based upon the already learned input pattern signals in a first predetermined learning stage; and
learning to classify the second input pattern signals into the classes in a second predetermined learning stage to generate already learned input pattern signals.

13. The method of learning a classification problem according to claim 12 wherein the first predetermined learning stage further comprises additional steps of:
updating weights between the input elements and middle elements;
updating a first vector indicating a central position of the RBF; and
updating a second vector indicating a range and a direction of the RBF.

14. The method of learning a classification problem according to claim 13 wherein the second predetermined learning stage further comprises additional steps of:
updating the first vector indicating the central position of the RBF; and
updating the second vector indicating the range and the direction of the RBF.

15. The method of learning a classification problem according to claim 14 wherein said predicting step further comprises additional steps of
predicting an area for each of the classes in the middle layer based upon the first vector and the second vector, and
selecting an output vector of the middle layer from a dimensional boundary point based upon the predicted area.

16. The method of learning a classification problem according to claim 15 wherein the area for each of the classes is designated as y in the following equation:
$$\begin{matrix}{f}_{net2} ( {c}^{( 0 )} ) = G ( {‖ y - {t}_{net2} ‖}_{{W}_{net2}}^{2} ) \\ = exp ( - ( y - {t}_{net2} ) {W}_{net2}^{T} {{W}_{net2} ( y - {t}_{net2} )}^{T} )\end{matrix}$$
where f_{net 2}(c⁽⁰⁾) is a desired output from the output layer, G is a Gaussian function, tₙₑₜ₂ is the first vector, and Wₙₑₜ₂ is the second vector.

17. The method of learning a classification problem according to claim 15 wherein the RBF is a predetermined Sigmoid function S.

18. The method of learning a classification problem according to claim 14 wherein the weights each indicating a relation between a pair of one of the input elements and a corresponding one of the middle elements, each of the weights being a product of a first predetermined value and a second predetermined value v_{i,j} that corresponds to i th one of the input elements and (0, j) th one of the middle elements.

19. The method of learning a classification problem according to claim 18 wherein the first predetermined value is αᵢ that corresponds to i th one of the input elements.

20. The method of learning a classification problem according to claim 19 wherein the first predetermined value αᵢ is based upon a splitting matrix for a predetermined wavelet splitting algorithm.

21. The method of learning a classification problem according to claim 20 wherein the first predetermined value αᵢ is a coefficient of the right term Ci⁽⁰⁾ which corresponds to the left term Ci⁽⁻ⁿ⁾ when the break down algorithm for wavelet as shown in the following equation is recursively applied from b=0, . . . , n−1.
$${c}_{k}^{( - b - 1 )} = 1 / 2 {\sum }_{1} {g}_{2 k - 1} {c}_{1}^{( - b )} , ( k = 0 , ⋯ , {2}^{n - b - 1} - 1 )$$
Where g₂ₖ₋₁ is a splitting matrix that depends upon a type of wavelet.

22. The method of learning a classification problem according to claim 18 wherein the first predetermined value is β_{i,z} that corresponds to (z, j) th one of the middle elements.

23. The method of learning a classification problem according to claim 21 wherein the first predetermined value β_{i,z} is based upon a splitting matrix for a predetermined wavelet splitting algorithm.

24. The method of learning a classification problem according to claim 23 wherein the first predetermined value βᵢ is a coefficient of the right term Ci⁽⁰⁾ which corresponds to the left term dₖ^{(-b-1)} when the break down algorithm for wavelet as shown in the following equation is recursively applied from b=0, . . . , n−1.
$${d}_{k}^{( - b - 1 )} = 1 / 2 {\sum }_{1} {h}_{2 k - 1} {c}_{1}^{( - b )} , ( k = 0 , ⋯ , {2}^{n - b - 1} - 1 )$$
Where h₂ₖ₋₁ is a splitting matrix that depends upon a type of wavelet.

25. The method of learning a classification problem according to claim 12 further comprising:
inputting a predetermined teaching signal value that corresponds to the first input pattern signals;
incrementing a first learning counter;
measuring a difference between an output value and the predetermined teaching signal value;
repeating the first learning stage based upon the measured difference; and
comparing the first learning counter to a predetermined number of first learning trials.

26. The method of learning a classification problem according to claim 12 further comprising:
inputting a predetermined teaching signal value that corresponds to the second input pattern signals;
incrementing a second learning counter;
measuring a difference between an output value and the predetermined teaching signal value;
repeating the second learning stage based upon the measured difference; and
comparing the second learning counter to a predetermined number of second learning trials.

27. The method of learning a classification problem according to claim 12 whereas a predetermined number of additional middle elements is added to the middle elements in the second learning stage.

28. A recording medium containing computer instructions for learning a classification problem for grouping into classes using a neural network, the neural network including input elements in an input layer, middle elements in a middle layer, and output elements and a predetermined radial basis function (RBF) in an output layer, the computer instructions performing the tasks of:
inputting first input pattern signals to the neural network;
learning to classify the first input pattern signals into classes in a first predetermined learning stage;
learning to classify the first input pattern signals into the classes in a second predetermined learning stage to generate already learned input pattern signals;
after the first learning stage and the second learning stage, predicting an input pattern based the already learned input pattern signals;
inputting second input pattern signals and the already learned input pattern signals;
learning to classify the second input pattern signals into classes based upon the already learned input pattern signals in a first predetermined learning stage; and
learning to classify the second input pattern signals into the classes in a second predetermined learning stage to generate already learned input pattern signals.

29. The recording medium containing computer instructions according to claim 28 wherein the first predetermined learning stage further comprises additional tasks of:
updating weights between the input elements and middle elements;
updating a first vector indicating a central position of the RBF; and
updating a second vector indicating a range and a direction of the RBF.

30. The recording medium containing computer instructions according to claim 29 wherein the second predetermined learning stage further comprises additional tasks of:
updating the first vector indicating the central position of the RBF; and
updating the second vector indicating the range and the direction of the RBF.

31. The recording medium containing computer instructions according to claim 30 wherein said predicting task further comprises additional tasks of
predicting an area for each of the classes in the middle layer based upon the first vector and the second vector, and
selecting an output vector of the middle layer from a dimensional boundary point based upon the predicted area.

32. The recording medium containing computer instructions according to claim 31 wherein the area for each of the classes is designated as y in the following equation:
f_{net 2}(c⁽⁰⁾=G(||y−t_{net 2}||_{w}_{_{net 2}}²)
=exp(−(y−t_{net 2})W_{net 2}^{T}W_{net 2}(y−t_{net 2})^{T})
Where f_{net 2}(c⁽⁰⁾) is a desired output from the output layer, G is a Gaussian function, tₙₑₜ₂ is the first vector, and Wₙₑₜ₂ is the second vector.
